(19) United States
(12) Patent Application Publication
(10) Pub. No.: US 2025/0300458 A1
(43) Pub. Date: Sep. 25, 2025

(54) FAULT MANAGED POWER SYSTEM

(71) Applicant: Panduit Corp., Tinley Park, IL (US)

(72) Inventors: Walid Balid, Orland Park, IL (US); Masud Bolouri-Saransar, Orland Park, IL (US)

(73) Assignee: Panduit Corp., Tinley Park, IL (US)

(21) Appl. No.: 19/055,123

(22) Filed: Feb. 17, 2025

Related U.S. Application Data
(60) Provisional application No. 63/568,502, filed on Mar. 22, 2024.

(51) Int. Cl. H02J 3/00; H02J 13/00

(52) U.S. Cl. CPC H02J 3/0012; H02J 13/00002; H02J 13/00007; H02J 13/0004

(57) ABSTRACT

A high voltage AC power fault managed power system is provided that includes accurate fault detection. The high voltage AC power fault managed power system includes a transmitter device and a receiver device that are coupled via a transmission line. The transmitter device and the receiver device obtain status information by monitoring a voltage or current on the transmission line, and share the detected status information with each other. High voltage power may continue to be transmitted through the transmission line when safety conditions are met based on the communication of status information between the transmitter device and the receiver device.

### CROSS-REFERENCE TO RELATED APPLICATION(S)

This application claims benefit to U.S. Provisional Patent Application No. 63/568,502, filed on Mar. 22, 2024, the entirety of which is hereby incorporated by reference herein.

### TECHNICAL FIELD

The present disclosure relates to a fault managed power system (FMPS) utilizing high-voltage alternating current (AC) power.

### BACKGROUND

Reliable and safe power distribution systems are the backbone to offering infrastructure solutions that people rely on in their day-to-day lives. In modern applications, providing reliable and safe power over longer distances may be made possible by utilizing high voltage power according to the Class 4 power systems defined by the National Electrical Code (NEC). Class 4 power systems are defined as power systems that offer significant power over long distances, while also abiding by safety requirements.

However, even within the Class 4 power system category, there are different solutions available. Therefore, the current disclosure describes a novel Class 4 power system that offers solutions not found in other systems.

SUMMARY

According to a non-limiting exemplary embodiment of the present disclosure, a fault managed power system using AC power is provided.

According to a non-limiting exemplary embodiment of the present disclosure, a method and system are provided for fault detection in an AC-FMPS, capable of identifying a range of fault conditions including human contact, arc faults, ground faults, short-circuits, connectivity faults, and voltage irregularities such as undervoltage, overvoltage, overcurrent, and unintended high-voltage on a power transmission line (PTL). This method involves monitoring the line voltage angle of rotation and initiating fault detection when it reaches a set value (Øs) or approaches the zero-crossing point. This includes disconnecting high-voltage switches at a power transmitter (e.g., AC-PTX) to isolate the PTL during detection, setting a predefined voltage level on the PTL at a power receiver (e.g., AC-PRX) side using a safety extra low voltage (SELV) source and a current sink, initiating a sampling of the PTL within a defined line testing window (LTW) in this isolated state, and comparing the sampled voltage against defined boundary conditions to ascertain the PTL's operational state. Finally, re-engaging the high-voltage switches at Øe if safe conditions are met, confirming the secure connection of the AC-PRX 2 and the absence of leakage current.

According to a non-limiting exemplary embodiment of the present disclosure, a method and system are provided for implementing a FMPS with high-voltage AC, characterized by maintaining continuous AC flow in a high-voltage power distribution system without needing voltage rectification or chopping and utilizing high-voltage AC power directly from the grid. This method includes providing direct power class conversion between Class 1 and Class 4, supporting various system topologies like point-to-point and multi-drop connections, and accommodating both single-phase and three-phase AC inputs and outputs in different configurations. The method adapts to either a High Resistance Midpoint Ground (HRMG) or mid-tap ground configuration to enhance line safety and adjusts voltage levels within the AC-FMPS to meet specific operational requirements. The method adapts AC load to be directly connected to the output of the receiver without isolation transformer or rectifying the output for DC loads. The method adapts the input transformer to share its isolated output with multiple transmitting channels and/or combine the rectified output of multiple receivers' channels to supply a higher load capacity

According to a non-limiting exemplary embodiment of the present disclosure, a method and system are provided for executing a Safety Check Procedure in various states, including after system initialization, post-recovery from a PTL fault incident, and during the LTW under normal system operation. This method may involve temporarily opening the high-voltage Switch, powering the PTL solely by the SELV source, and loading it with the reference current sink on a power receiver (e.g., AC-PRX). The method may further include testing the sampled PTL voltage against three boundaries, each defined by two thresholds, with the boundaries being configurable based on various operational configurations.

According to a non-limiting exemplary embodiment of the present disclosure, a method and system are provided for employing an angle of rotation detector and a zero-crossing detector to monitor the phase angle and zero-crossing points of the AC waveform within the PTL. This method involves triggering the LTW at predetermined phase angles, conducting safety checks, fault detection, or system diagnostics within the LTW period, sampling the PTL voltage and current within a defined window using a power transmitter (e.g., AC-PTX) and/or a power receiver (e.g., AC-PRX), and testing the sampled voltage against predefined boundaries set by threshold pairs to maintain system safety and operational integrity.

According to a non-limiting exemplary embodiment of the present disclosure, a method and system are provided for detecting abnormalities such as overvoltage, undervoltage, overcurrent, or short-circuit conditions when the power switch is closed, responding appropriately by shutting down units and requiring operator checks.

According to a non-limiting exemplary embodiment of the present disclosure, a method and system are provided for conducting self-diagnosis tests (Test-the-Tester) to ensure the integrity of safety detection circuits in the AC-FMPS. This includes performing self-validation of safety detection circuits by introducing predefined voltages, loads, and impedances to the PTL as part of the self-check and comparing measurements obtained during the self-check to reference values to assess the response of the safety detection circuits to introduced fault scenarios.

According to a non-limiting exemplary embodiment of the present disclosure, a method and system are provided for integrating an RF communication layer in an AC-FMPS, enhancing system functionalities. This method includes implementing an RF communication layer over the PTL within the AC-FMPS, utilizing the RF layer for real-time communication between different units of the AC-FMPS, transmitting control signals, system status, and diagnostic data. It enhances system safety through immediate RF communication in response to detected faults or operational anomalies, facilitates efficient system management and control via RF communication, and integrates data reporting functionalities through the RF layer for comprehensive system performance analysis and early detection of potential issues.

A detailed description of this and other non-limiting exemplary embodiments of a fault managed power system using AC power and a method for implementing such a fault managed power system using AC power is set forth below together with the accompanying drawings.

### BRIEF DESCRIPTION OF THE DRAWINGS

FIG. 1 illustrates a circuit architecture of an AC-FMPS, according to a non-limiting exemplary embodiment of the present disclosure.

FIG. 2 illustrates a circuit architecture across two channels of the AC-FMPS shown in FIG. 1, according to a non-limiting exemplary embodiment of the present disclosure.

FIG. 3 illustrates a system diagram for a point-to-point architecture of the AC-FMPS shown in FIG. 1, according to a non-limiting exemplary embodiment of the present disclosure.

FIG. 4 illustrates a system diagram for a point-to-point architecture across multiple channels of the AC-FMPS shown in FIG. 3, according to a non-limiting exemplary embodiment of the present disclosure.

FIG. 5 illustrates a system diagram for a multi-drop architecture of the AC-FMPS shown in FIG. 3, according to a non-limiting exemplary embodiment of the present disclosure.

FIG. 6 illustrates a system diagram for an exemplary AC-FMPS including a rectifier circuit for when a direct current (DC) load is connected, according to a non-limiting exemplary embodiment of the present disclosure.

FIG. 7 illustrates a system diagram for an exemplary AC-FMPS configured to transmit to multiple channels of transmitters, according to a non-limiting exemplary embodiment of the present disclosure.

FIG. 8 illustrates a system diagram for an exemplary AC-FMPS configured to transmit to multiple channels of transmitters and including a rectifier circuit for when a DC load is connected, according to a non-limiting exemplary embodiment of the present disclosure.

FIG. 9 illustrates a system diagram for an exemplary AC-FMPS including a three phase AC power source and a single phase load, according to a non-limiting exemplary embodiment of the present disclosure.

FIG. 10 illustrates a system diagram for an exemplary AC-FMPS including a three phase AC power source and a three phase load, according to a non-limiting exemplary embodiment of the present disclosure.

FIG. 11 illustrates an exemplary graph showing a plot of a monitored power over a transmission line of an AC-FMPS, according to a non-limiting exemplary embodiment of the present disclosure.

FIG. 12 illustrates an exemplary graph showing a plot of a monitored power over a transmission line of an AC-FMPS, according to a non-limiting exemplary embodiment of the present disclosure.

FIG. 13 illustrates an exemplary graph showing a plot of a monitored power over a transmission line of an AC-FMPS, according to a non-limiting exemplary embodiment of the present disclosure.

FIG. 14 illustrates an exemplary graph showing a plot of a monitored power over a transmission line of an AC-FMPS, according to a non-limiting exemplary embodiment of the present disclosure.

FIG. 15 illustrates an exemplary graph showing a plot of a monitored power over a transmission line of an AC-FMPS, according to a non-limiting exemplary embodiment of the present disclosure.

FIG. 16 illustrates an exemplary flowchart describing an initialization process operation of an AC-FMPS, according to a non-limiting exemplary embodiment of the present disclosure.

FIG. 17 illustrates an exemplary flowchart describing a safety check operation of an AC-FMPS, according to a non-limiting exemplary embodiment of the present disclosure.

FIG. 18 illustrates the graph shown in FIG. 11 further including an overlay of voltage boundary conditions according to a first configuration, according to a non-limiting exemplary embodiment of the present disclosure.

FIG. 19 illustrates the graph shown in FIG. 12 further including an overlay of voltage boundary conditions according to a second configuration, according to a non-limiting exemplary embodiment of the present disclosure.

FIG. 20 illustrates the graph shown in FIG. 13 further including an overlay of voltage boundary conditions according to a third configuration, according to a non-limiting exemplary embodiment of the present disclosure.

FIG. 21 illustrates the graph shown in FIG. 14 further including an overlay of voltage boundary conditions according to a fourth configuration, according to a non-limiting exemplary embodiment of the present disclosure.

FIG. 22 illustrates the graph shown in FIG. 15 further including an overlay of voltage boundary conditions according to a fifth configuration, according to a non-limiting exemplary embodiment of the present disclosure.

FIG. 23 illustrates an exemplary flowchart describing a main procedure operation of an AC-FMPS, according to a non-limiting exemplary embodiment of the present disclosure.

FIG. 24 illustrates an exemplary graph plotting a relationship of voltage and angle of rotation over a cycle of an AC-FMPS, according to a non-limiting exemplary embodiment of the present disclosure.

### DETAILED DESCRIPTION

Detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Described herein is a fault managed power system using AC power, or otherwise referred to as Alternating Current Fault Managed Power System (AC-FMPS). The AC-FMPS disclosed herein is a novel approach in high-voltage AC power delivery and distribution. The AC-FMPS, innovatively designed to align with UL Standard 1400-1, ensures enhanced safety, reliability, and installation ease in Class 4 power systems as defined by the National Electric Code (NEC). This AC-FMPS stands apart by maintaining continuous AC flow through conductor cables, thus eliminating the need for the voltage chopping found in pulse power systems. The AC-FMPS disclosed herein is configured to intelligently manage power delivery, adapting voltage levels to client-specific needs for powering various end devices. For example, the AC-FMPS disclosed herein may include embodiments that provide +/−57 VDC, +/−380V, or other high voltage power.

The AC-FMPS integrates a comprehensive fault detection system, capable of identifying diverse fault conditions such as human contact, arc faults, ground faults, short-circuits, connectivity issues, and voltage irregularities. For example, upon detecting a fault, the AC-FMPS swiftly disengages the high-voltage output, adhering to a predefined safety response curve. The AC-FMPS employs a Safety Extra Low Voltage (SELV) mechanism, conforming to the “let-go” threshold described in UL1400-1, to ensure line safety before reactivation.

A significant innovation of AC-FMPS lies in its direct power class conversion capability (e.g., from Class 1 to Class 4) for AC Power. This feature enhances power efficiency and reduces switching stress, thus making the system safer and more noise efficient. The simplicity of the copper conductor setup facilitates easier and cost-effective installation, negating the need for specialized electrical expertise and infrastructure.

Additionally, the AC-FMPS incorporates a multifaceted RF communication layer over the same transmission line. This feature not only augments system safety and management but also provides scalable control and data reporting functionalities, paving the way for a more adaptable and manageable power distribution network. This disclosure henceforth refers to this innovative AC-FMPS solution, marking a significant advancement in the field of power distribution technology.

The development of Class 4 power systems represents a paradigm shift in remote power delivery, prioritizing optimal safety and efficiency. These Class 4 power systems, characterized by a maximum voltage of 450V and not being power limited, set new standards in power distribution technology. Central to Class 4 systems is their design philosophy, which places paramount importance on safety. Integrated safety circuits in the power source/transmitter and receiver meticulously control power delivery, monitor for potential faults, and restrict energy and power during fault occurrences.

Recent advancements in regulatory frameworks, such as the publication of UL 1400-1 and UL 1400-2, have been instrumental in defining and shaping the future of fault-managed power systems (FMPS). UL 1400-1 outlines the essential requirements for FMPS, while UL 1400-2 delves into the safety considerations and evaluation criteria for Class 4 circuit cabling. These documents, submitted through the ANSI process, are set to establish new industry standards.

The FMPS, designated as a Class 4 system under NFPA/NEC guidelines, revolutionizes safety in power distribution. It is an energy-limited power source designed to mitigate shock and fire hazards uniquely. FMPS operates by continuously monitoring the wiring for any faults. In the event of a fault, such as accidental human contact with exposed wires, FMPS responds instantly, reducing fault energy to a safe level.

A standout feature of FMPS is its capability to deliver high power levels-significantly exceeding the limitations of traditional systems like 100 W Class 2 systems or 100-meter Power over Ethernet (POE) systems. For instance, FMPS can transmit 2 kW over 400 meters or 400 W over 2000 meters using a pair of 18 AWG wires, achieving efficiencies greater than 70%. Moreover, FMPS ensures human operator touch safety and operates under strict safety guidelines to prevent hazardous events.

The system facilitates centralized remote power management and distribution, enabling power metering and backup without necessitating cable conduits. Compared to lower voltage Class 2 power systems, Class 4 systems (e.g., up to 450V) can transmit more power over longer distances using thinner copper conductors.

The present AC-FMPS solution described herein provides the ability to transform a Class 1 Power System into a Class 4 system, without altering the current's form, marking a significant leap in power distribution efficiency and safety.

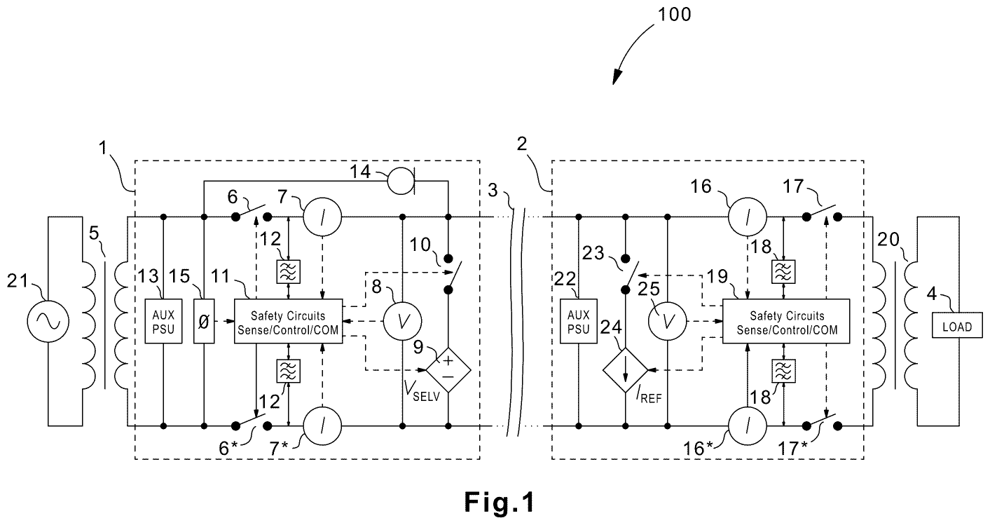

FIG. 1 shows a circuit architecture diagram of a single channel AC-FMPS 100. The AC-FMPS 100 includes three (3) main elements: 1) an AC Power Transmitter (AC-PTX) 1, an AC Power Receiver (AC-PRX) 2, and a power transmission line (PTL) 3. This view of the architecture for the AC-FMPS 100 shown in FIG. 1 also incorporates essential sub-systems, such as filters 12 on the AC-PTX 1 side and filters 18 on the AC-PRX 2 side, that super impose the high-voltage power and RF communication data over the PTL 3.

A high-voltage AC power source 21, adaptable to various AC voltages and frequencies, is included in the AC-FMPS 100. The high-voltage AC power source 21 may be a representation of a grid. An isolation transformer 5 ensures grid isolation while enabling voltage adjustments (i.e., step-up or step-down) and potential frequency conversion (e.g., 50 Hz to 400 Hz), with maximum output voltage up to ±225V AC Peak. This output from the high-voltage AC power source 21 may include a High Resistance Midpoint Ground (HRMG) configuration or a mid-tap grounding configuration.

Safety-level power switches 6 are meticulously controlled by the safety circuits 11. Additional switches 6* may also be used to cut-off the current on the return path in normal operation of the AC-FMPS 100 or when the AC-FMPS 100 is OFF.

Current sensing circuits 7, 7* are ultra-precise current sensing circuits for continuous monitoring of the current on the PTL 3 and leakage current of the AC-FMPS 100. Redundant voltage sensing circuits 8 are included to ensure real-time voltage monitoring on the PTL 3.

A SELV voltage source 9 applies a Safety Extra Low Voltage (SELV) on the PTL 3 that may be used to: 1) verify safety conditions on the PTL 3 before reactivating the high voltage power that will be transmitted onto the PTL 3; 2) provide a line reference voltage during a Line Testing Window (LTW) period; and/or 3) power-up the AC-PTX 2 during a system initialization period, as well as after a recovery from a fault incident to establish the communication link between the AC-PTX 1 and the AC-PRX 2. A switch 10 may be used to engage and disengage the SELV voltage source 9.

A differential RF communication signal is super imposed onto the PTL 3 via a differential, high voltage, coupling filter 12 on the AC-PTX 1 side and a corresponding differential, high voltage, coupling filter 18 on the AC-PRX 2 side, which may be used for system safety, management, control, and data reporting for ensuring the AC-FMPS is a scalable and manageable power distribution system.

An auxiliary power supply (AUX-PSU) 13 is included to power up the circuitry on the AC-PTX 1 from the input source voltage. An auxiliary power supply (AUX-PSU) 22 is also included on the AC-PRX 2 to power up the circuitry on the AC-PRX 2 directly from the PTL 3.

A current limiter 14 is included for soft starting the AC-FMPS 100, ensuring a soft transition from and to the line testing window (LTW), and/or providing a safe, current limited, path to power up the AC-FMPS 100 and check for presence of the AC-PRX 2 on the PTL 3.

A circuit detector 15 may be an angle of rotation detector and/or a zero-crossing detector. This circuit detector 15 is used by the safety circuits 11 for executing a PTL Safety Check Procedure within the line testing window (LTW).

The AC-PRX 2 uses a voltage sensing circuit 25 for line voltage monitoring and current detectors 16, 16* for current monitoring.

A current sink 24 serves as a reference current sink used in conjunction with the SELV voltage source 9, and/or a current limiter 14, by the fault detection circuitries included in the AC-FMPS 100. This includes, for example, validating a receiver disconnect condition, a touch fault condition, an arc fault condition, and a ground fault detection condition. The current sink 24 can be configured to be active continuously or only when the SELV voltage source 9 is engaged, controlled by a switch 23.

Switches 17, 17* provide a mechanism to disconnect the load under various scenarios, such as: 1) a load disconnect condition, 2) a system initialization condition, 3) a system calibration condition, and/or 4) a system validation/Test-the-Tester condition. The switch 17 and/or the switch 17* may be optional to include on the AC-PRX 2.

The safety circuits 11, 19 on the AC-PTX 1 and the AC-PRX 2, respectively, maintain the system's integrity by handling real-time line condition checks, power transmission and conversion control, and communication signal encoding and decoding.

The output from the AC-PRX 2 is coupled to the load 4, via another isolation transformer 20, that provide an isolation to the load 4, allows output voltage adjustment (i.e., step-up or step-down), and provides isolation between different channels, safeguarding the system's integrity by effectively preventing leakage currents, back feeds, or return paths under fault conditions.

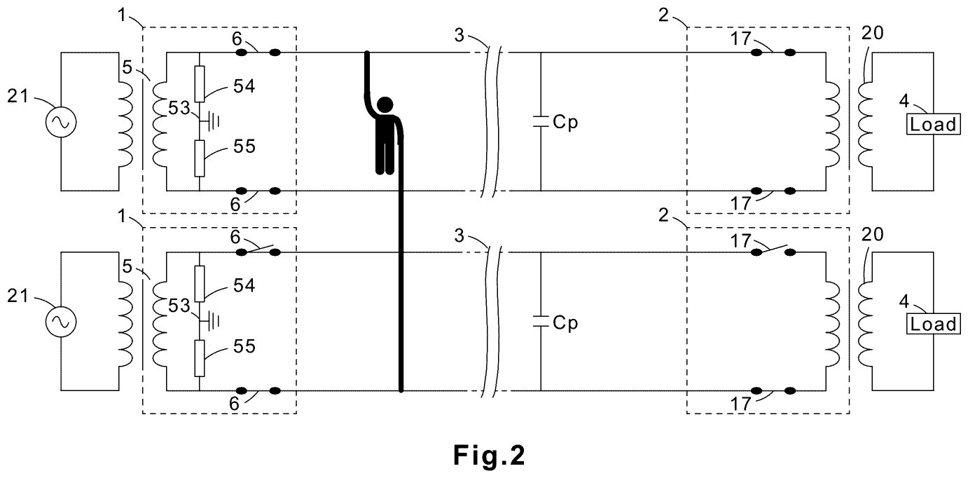

This isolation provided by the isolation transformer 5 and/or isolation transformer 20 is particularly vital in preventing cross-transmitter connection issues between lines on different channels, as illustrated in FIG. 2, ensuring each channel operates independently and safely. In FIG. 2, an exemplary fault touch condition is being shown between a line on channel 1 to another line on channel 2. The output of the isolation transformer 20 can be rectified for DC loads.

As shown in FIG. 2, a High Resistance Midpoint Ground (HRMG) 53 is formed by two resistors 54, 55.

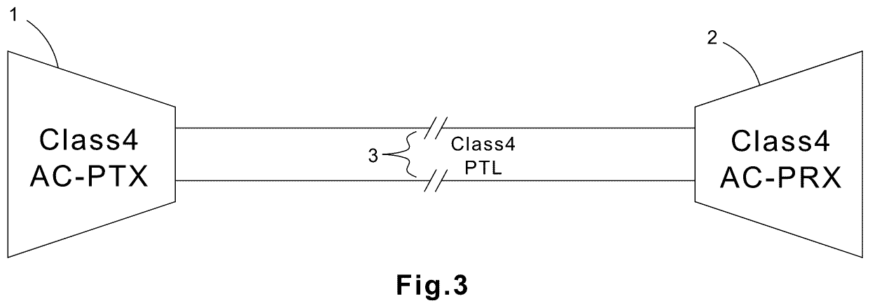

The architecture for the AC-FMPS 100 depicted in FIG. 1 supports several configurations, such as multiple AC-PTX 1 channels connecting to AC-PRX 2 channels over single-pair PTLs 3 in a point-to-point manner, as illustrated in the configuration shown in FIG. 3. This allows for system expansion under a centralized management point.

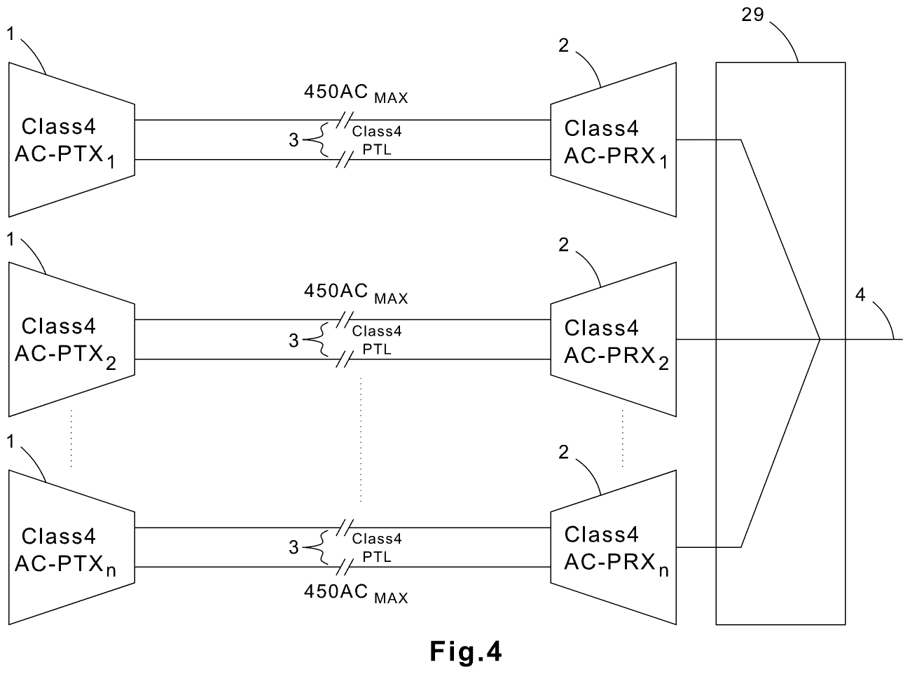

The AC-FMPS 100 also supports several AC-PRX 2 channels to be combined to support a higher output power, as illustrated in the configuration shown in FIG. 4. An integrated power combiner circuit 29 may be included in such configurations where multiple channels are combined, where the integrated power combiner circuit 29 employs n-controlled output switches, n-reverse current/polarity blocking/protection controllers, n-load sharing controllers, and a sophisticated load startup algorithm. The load 4 may then be connected to the output from the integrated power combiner circuit 29.

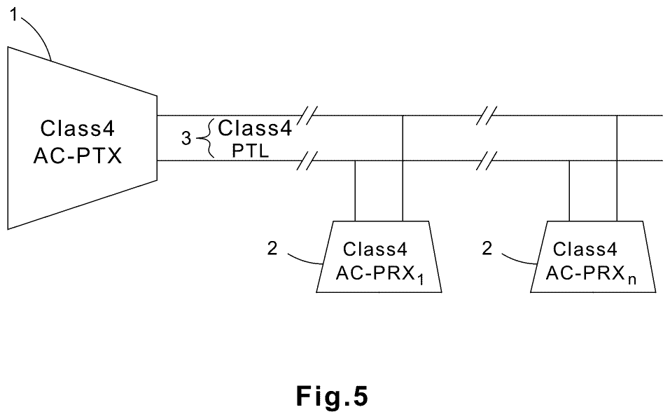

The interconnection between the AC-PTX 1 and the AC-PRX 2 is not only limited to point-to-point connections as illustrated by the configurations shown in FIG. 3 and FIG. 4, but may also include support for a “bus or multi-drop” connection topology as illustrated by the configuration shown in FIG. 5. In the “bus or multi-drop” connection topology configuration shown in FIG. 5, a single AC-PTX 1 can drive several AC-PRX 2 channels. Each AC-PRX 2 channel is addressed with a unique address that is assigned at the startup of the system over the RF communication link.

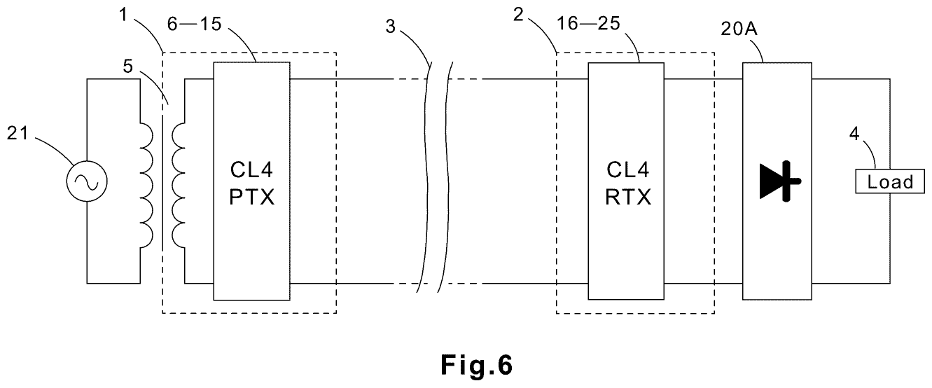

The concept implementation is not limited to the use of an isolation transformer 20, as shown by the AC-FMPS 100 in FIG. 1. According to some embodiments, an AC load can be directly connected to the output of the receiver AC-PRX 2 if voltage conversion (step-up or step-down) is not required. If the load is a DC load, a rectifier 20A can be used instead to connect the DC load 4 to the receiver AC-PRX 2, as shown in FIG. 6.

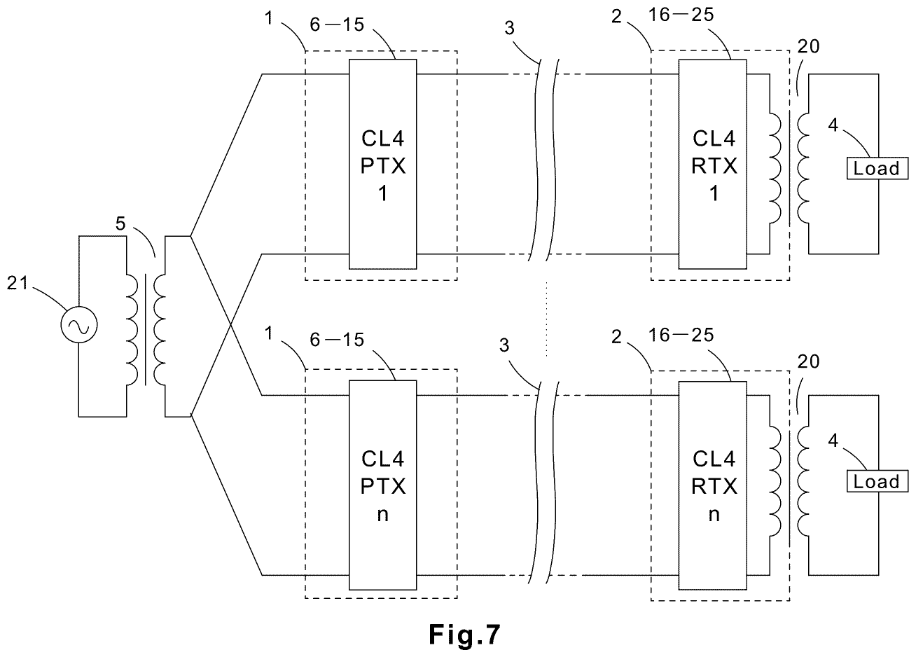

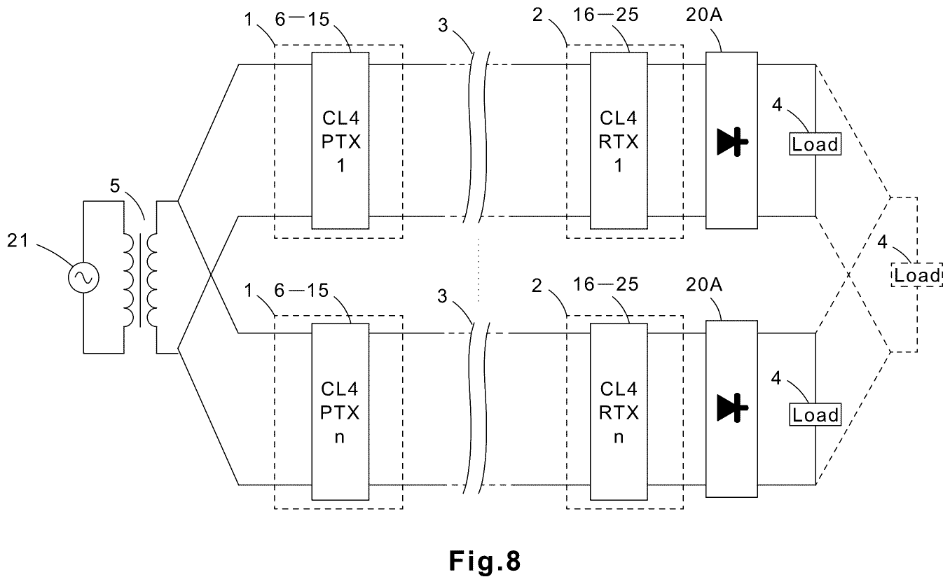

The input isolation transformer 5 shown on the side of the transmitter AC-PTX 1, may also share its isolated output with multiple channels of transmitters AC-PTX 1, as depicted in FIG. 7. Similarly, the implementation can be applied to the receiver rectified output so that multiple receivers output channel can be combined to supply a higher load capacity, as depicted by the configuration shown in FIG. 8.

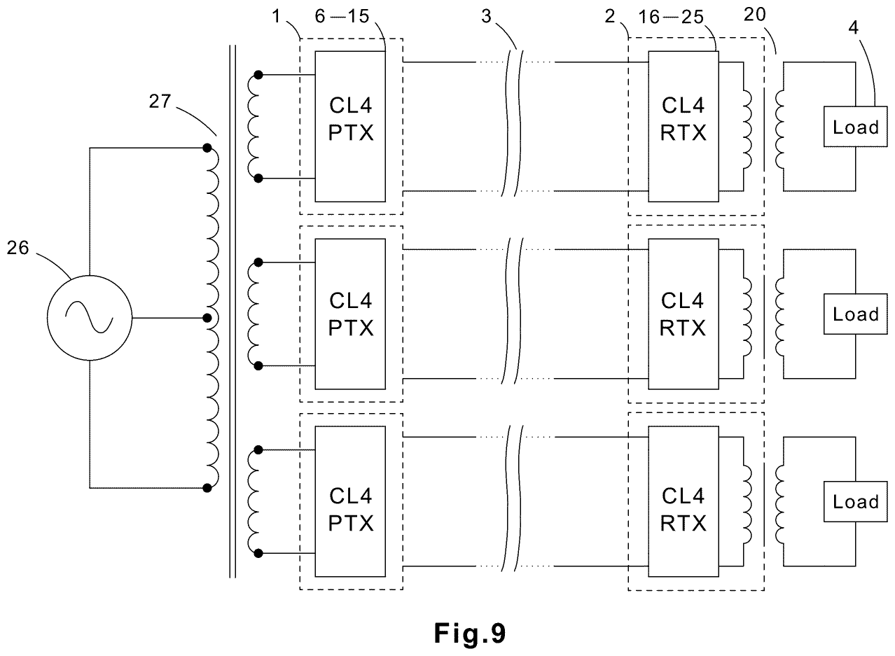

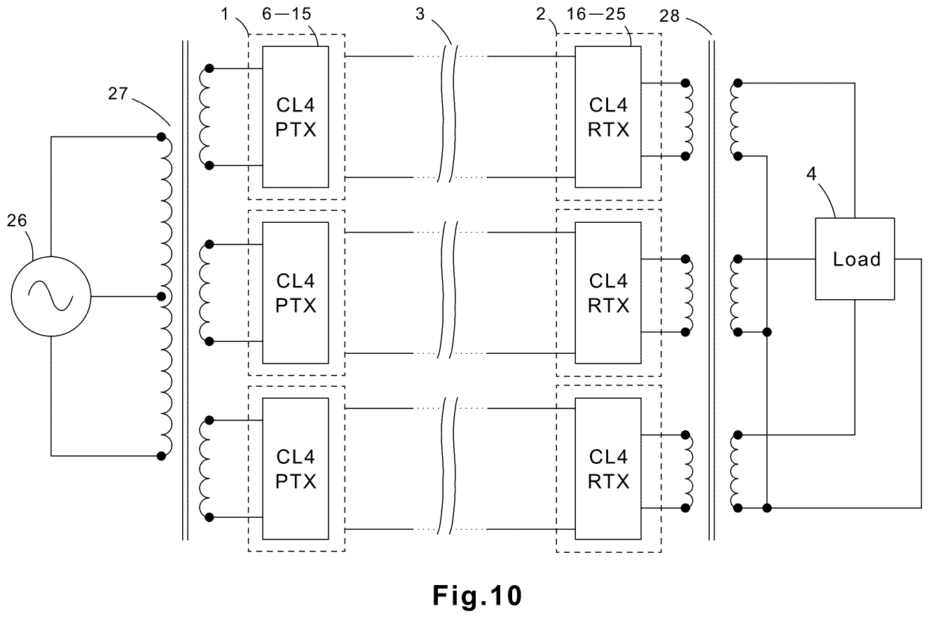

The concept implementation is also not limited to single phase AC Input. For example, a Three-phase isolation transformer 27 can be used to power up the AC-FMPS 100 as shown in FIG. 9 and FIG. 10, using an AC power source 26. FIG. 9 shows an embodiment of the AC-FMPS 100 with three-phase AC power source 26 and a single phase load 4. FIG. 10 shows an embodiment of the AC-FMPS 100 with three-phase AC power source 26 and a three phase load 4. Each phase can supply one or multiple transmitter devices AC-PTX 1. The output from the transformer 28 can be configured in any form including Delta, Wye, Mid-Tap, or kept completely isolated for three phase loads or single-phase loads.

The AC-FMPS 100 is configured to offer fault detection features for detecting undesirable fault conditions that may occur on the PTL 3. These fault detection features are based on sensing and monitoring the transmission line voltage and/or current on the PTL 3 during a periodic “Line Testing Window” (LTW) period. The AC-PTX 1 output is meticulously controlled by safety-rated, redundant power switches 6, 6* included on the AC-PTX 1. The switch 6 has two functions: 1) Enabling/Disabling the high-voltage output from the AC-PTX 1; and 2) Floating the Line for fault detection in a specific angle of rotation of the AC Line over a predefined LTW. An additional switch 6* may also be included to cut-off the current on the return path under normal operation of the AC-FMPS 100, or when the AC-FMPS 100 is OFF.

The safety circuits 11 on the AC-PTX 1 control the power switches 6, 6* based on the instantaneous output of the circuit detector 15 (e.g., angle of rotation detector), to execute the Safety Check Procedure on the PTL 3 within the period of LTW.

The trigger point of the LTW is defined by the angle of rotation configuration (i.e., positive cycle, negative cycle, during the 0-90° angle of rotation, etc.). The period of the LTW may be configured based on the frequency of line voltage or characteristics of the PTL 3. The following configurations detail different implementations.

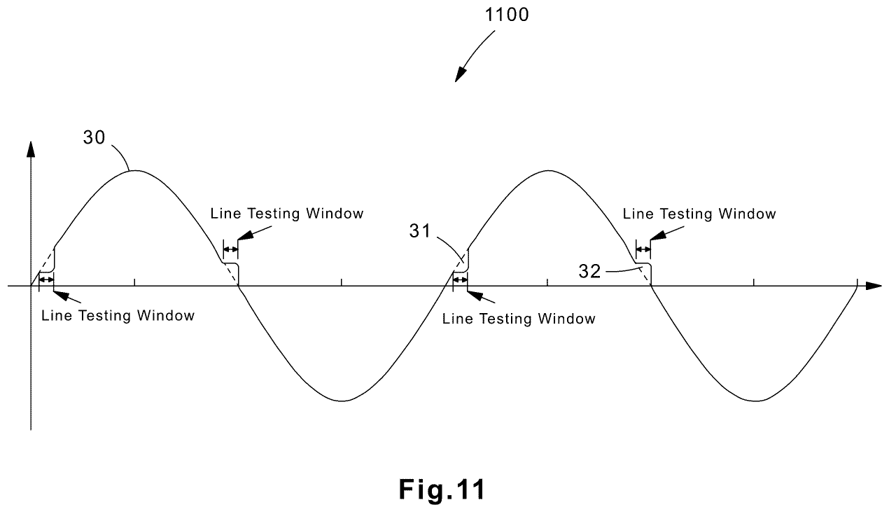

FIG. 11 shows a graph 1100 monitoring the power transmitted over the PTL 3 according to a Configuration-1. The graph 1100 is depicted to plot voltage (y-axis) against time (x-axis). The plot of the graph 1100 may be used to test for faults on the PTL 3 during specified operational periods of the AC-FMPS 100 such as, for example, the positive cycles. For example, in this Configuration-1 illustrated by the graph 1100 in FIG. 11, the redundant power switches 6 are controlled to trigger the LTW at certain times during the Positive Cycle 30 of the sinusoidal waveform in one of the following angles of rotation:
LTW is set during the Positive Cycle 0-90° (31), or
LTW is set during the Positive Cycle 90-180° (32), or
LTW is set during the Positive Cycles 0-90° (31) and 90-180° (32).

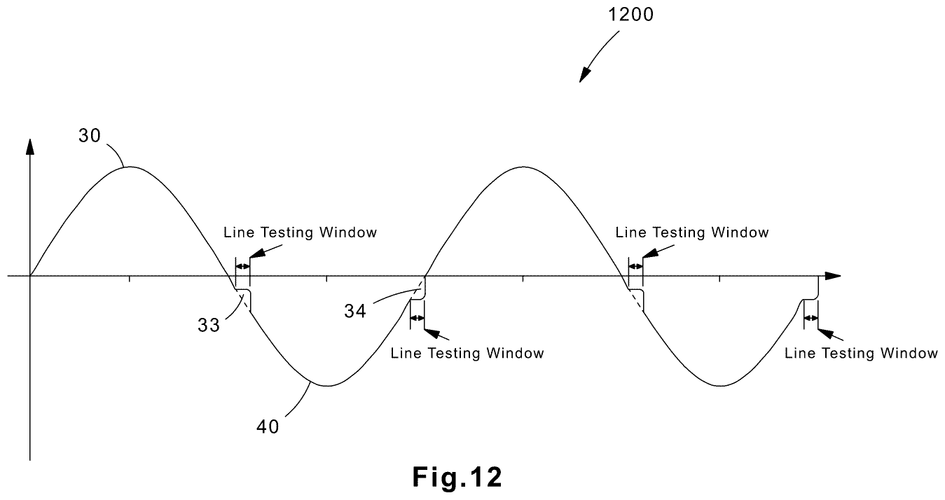

FIG. 12 shows a graph 1200 monitoring the power transmitted over the PTL 3 according to a Configuration-2. The graph 1200 is depicted to plot voltage (y-axis) against time (x-axis). The plot of the graph 1200 may be used to test for faults on the PTL 3 during specified operational periods of the AC-FMPS 100 such as, for example, the negative cycles. For example, in this Configuration-2 illustrated by the graph 1200 in FIG. 12, the redundant power switches 6 are controlled to trigger the LTW at certain times during the Negative Cycle 40 of the sinusoidal waveform in one of the following angles of rotation:
LTW is set during the Negative Cycle 180-270° (33), or
LTW is set during the Negative Cycle 270-360° (34), or
LTW is set during the Negative Cycles 180-270° (33) and 270-360° (34).

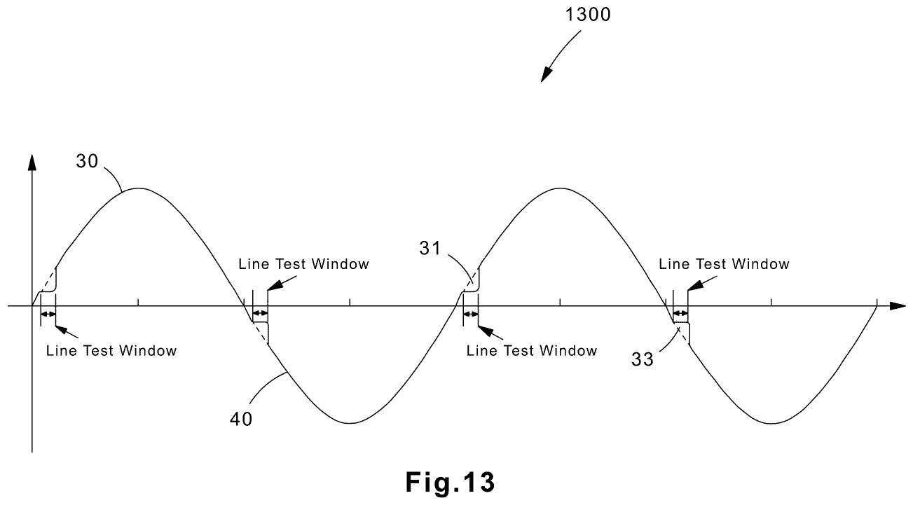

FIG. 13 shows a graph 1300 monitoring the power transmitted over the PTL 3 according to a Configuration-3. The graph 1300 is depicted to plot voltage (y-axis) against time (x-axis). The plot of the graph 1300 may be used to test for faults on the PTL 3 during specified operational periods of the AC-FMPS 100 such as, for example, the positive cycle 30 and/or negative cycle 40. For example, in this Configuration-3 illustrated by the graph 1300 in FIG. 13, the redundant power switches 6 are controlled to trigger the LTW at certain times during the Positive Cycle 30 and/or Negative Cycle 40 of the sinusoidal waveform in one of the following angles of rotation:
LTW is set during the Positive 0-90° Cycle (31), or
LTW is set during the Negative 180-270° Cycle (33), or
LTW is set during the Positive 0-90° (31) & Negative 180-270° (33) Cycles.

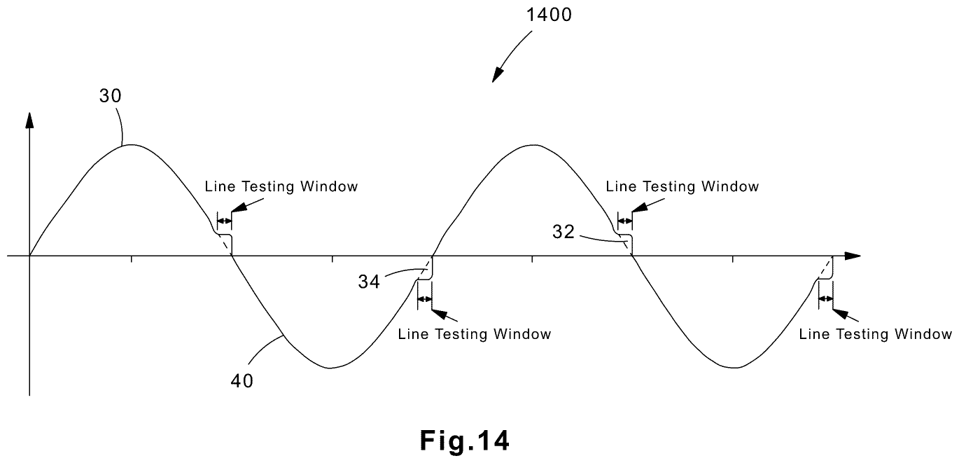

FIG. 14 shows a graph 1400 monitoring the power transmitted over the PTL 3 according to a Configuration-4. The graph 1400 is depicted to plot voltage (y-axis) against time (x-axis). The plot of the graph 1400 may be used to test for faults on the PTL 3 during specified operational periods of the AC-FMPS 100 such as, for example, the positive cycle 30 and/or negative cycle 40. For example, in this Configuration-4 illustrated by the graph 1400 in FIG. 14, the redundant power switches 6 are controlled to trigger the LTW during the Positive Cycle 30 and/or Negative Cycle 40 of the sinusoidal waveform in one of the following angles of rotation:
LTW is set during the Positive Cycle 90-180° (32), or
LTW is set during the Negative Cycle 270-360° (34), or
LTW is set during the Positive Cycles 90-180° (32) and Negative Cycles 270-360° (34).

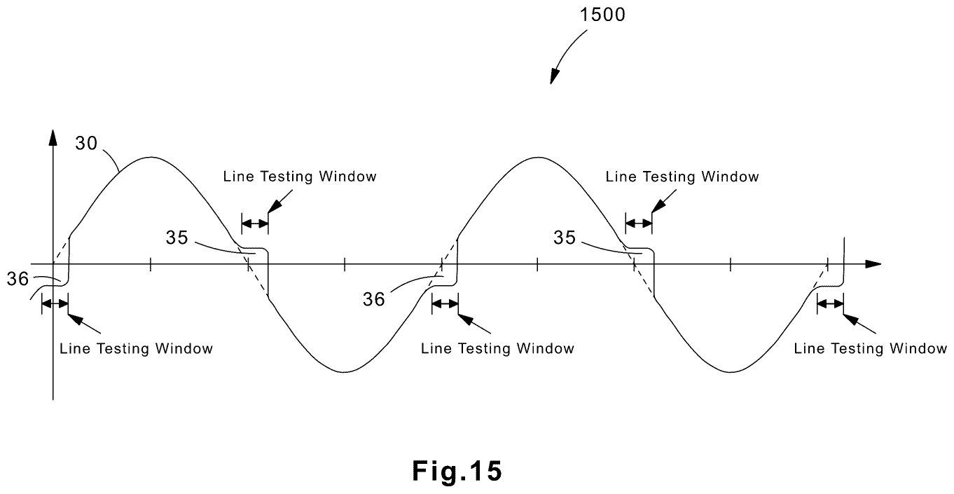

FIG. 15 shows a graph 1500 monitoring the power transmitted over the PTL 3 according to a Configuration-5. The graph 1500 is depicted to plot voltage (y-axis) against time (x-axis). The plot of the graph 1500 may be used to test for faults on the PTL 3 during specified operational periods of the AC-FMPS 100 such as, for example, around a zero crossing period between a positive cycle 30 and a negative cycle 40, or the reverse from a negative cycle 40 to a positive cycle 30. For example, in this Configuration-5 illustrated by the graph 1500 in FIG. 15. The redundant power switches 6 are controlled to trigger the LTW during a transition between the Positive Cycle 30 and/or Negative Cycle 40 of the sinusoidal waveform in one of the following angles of rotation about the zero crossing:
LTW is set around the Zero-Crossing by introducing a short low voltage pulse, or
LTW is set around the Zero-Crossing during the Transition from Positive to Negative Cycle (35), and/or
LTW is set around the Zero-Crossing during the Transition from Negative to Positive Cycle (36).

The primary safety related circuits and functions are held in safety circuits 11 and safety circuits 19. These functions employ fault detection circuits that check the PTL 3 for different fault incidents, including, but not necessarily limited to:
1) Tests when PTL in High Impedance State—e.g., switch 6 is open:
   a. Human Touching Cable: Introduces a human-body impedance across PTL.
   b. Short-circuited Cable: Introduces a very low impedance to PTL.
   c. Cable/Receiver Disconnect: Causes a high impedance on the PTL (i.e., floating).
   d. Arcing Event: Introduces a series resistance to the PTL as the resistance of an arc increases when it passes through a zero-crossing point due to the de-ionization of plasma.

e. Ground Fault Event: Introduces a human-body impedance between a Line and Ground.

f. Unintended High-Voltage: A hazardous voltage is detected on the line during OFF time.
2) Tests when PTL in Low Impedance State—e.g., switch 6 is closed:
   a. Undervoltage Case: PTL Voltage drops below a predefined threshold.
   b. Overvoltage Case: PTL Voltage overshoots or exceeds a predefined threshold.
   c. Overloading/Short Circuit Case: PTL Current exceeds a predefined threshold.

Under, for example, any one or more of the above exemplary fault incidents, the safety circuits 11 in the AC-PTX 1 may collaborate with the safety circuits 19 in the AC-PRX 2 to detect a change in the PTL 3 voltage and current profiles, and instantly disconnect the high-voltage AC power source 21 by opening the switch 6 and/or the switch 6*.

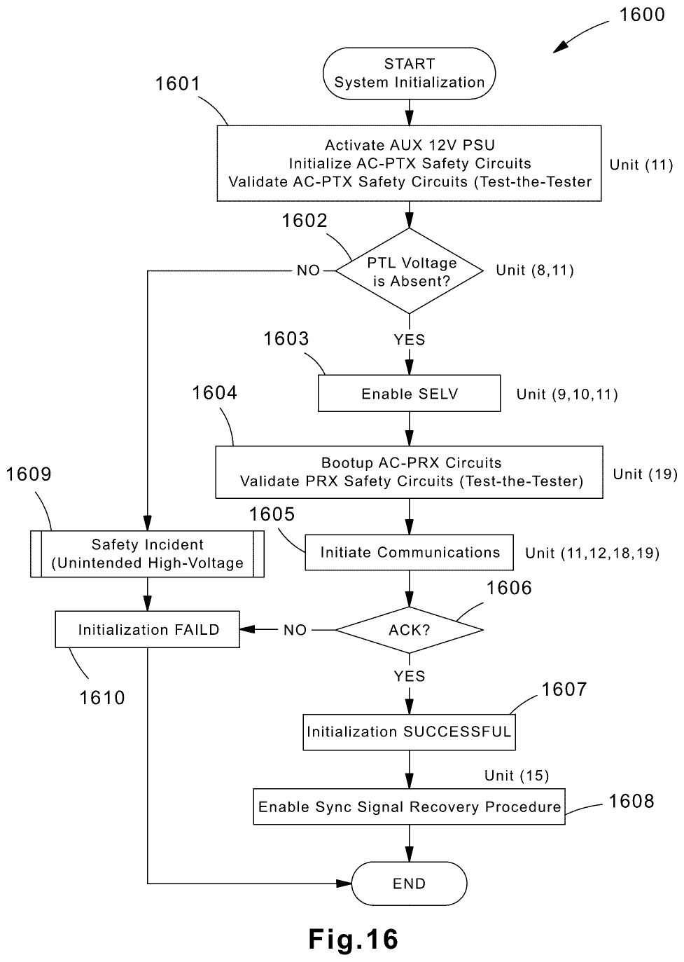

System Initialization Process: The AC-PTX 1 employs a SELV voltage source 9 (e.g., a current limited voltage source) that is controlled though the switch 10 by the Safety Circuits 11. The main function of the SELV voltage source 9 during system initialization, as well as, after a recovery from a fault incident, is powering-up the AC-PRX 2 to establish the communication link between the AC-PTX 1 and the AC-PRX 2. According to an embodiment, the System Initialization Process may be described in more detail by the flowchart 1600 shown in FIG. 16.

The initialization process starts by activating the auxiliary power supply (AUX-PSU) 13 that powers up the AC-PTX 1 circuits, at 1601. The safety circuits 11 run a self-diagnosis test (i.e., Test-the-Tester) to self-validate the integrity of the various safety detection circuits included in the safety circuits 11. The self-diagnosis test is based on utilizing the SELV voltage source 9 to introduce calibrated voltages to the PTL 3 and on utilizing the redundant voltage sensing circuits 8 and the voltage sensing circuit 25 to sample the PTL voltage and current. Then the current sink 24 introduces defined loads to PTL 3 while the current sensing circuit 7 and the voltage sensing circuits 8 sample PTL. The AC-PRX 2 sends collected measurements to the AC-PTX 1, which in turn runs an analysis to verify the integrity of the sensing circuits. The AC-PTX 1 may also set the current limiter 14 to supply a current limited High Voltage to the PTL 3 and activate the safety circuits 11 to validate their function; they should trip. The AC-PTX 1 may also momentarily introduce an impedance at its output to emulate a human-body touch to validate the safety circuits functionality.

If an unintended voltage is detected on the PTL 3, at 1602, then a safety incident is flagged, at 1609, and the initialization process fails, at 1610. However, if all is validated, at 1601, and the safety circuits 11 leverage the voltage sensing circuits 8 to sample the PTL 3 and confirm the absence of any unintended voltage, at 1602, then the initialization process proceeds on.

Once confirmed, the safety circuits 11 enables the SELV voltage source 9, which powers-up a low power AUX-PSU 22 and the safety circuits 19 on the AC-PRX 2, at 1603. Once powered, the AC-PRX 2 executes self-validation, at 1604, and both the AC-PTX 1 and the AC-PRX 2 initiate a communication link over the PTL 3, at 1605. Once initiated, a clock recovery procedure is enabled. The safety circuits 11 rely on the PTL frequency for calculating and detecting the angle of rotation. The circuit detector 15 runs in the background to generate a synchronization signal from the PTL 3.

If an acknowledgement is not received, at 1606, then the initialization process fails, at 1610. If an acknowledgement is received, at 1606, then the initialization process is found successful, at 1607, and a sync signal recover procedure is enabled, at 1608.

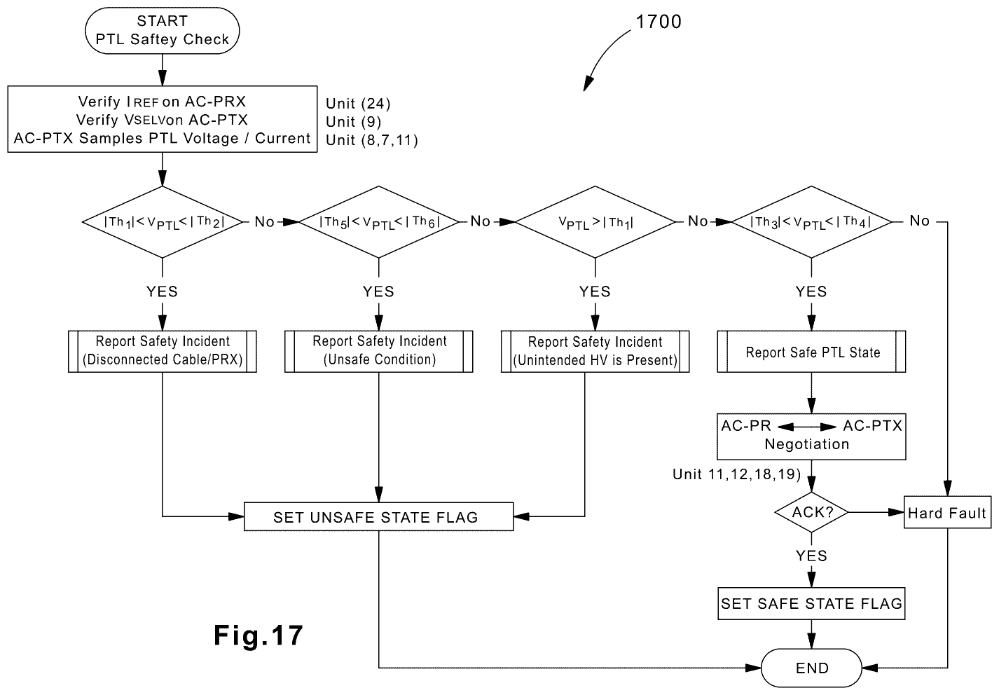

Safety Check Procedure: According to an embodiment, FIG. 17 illustrates an exemplary flowchart 1700 describing a PTL safety check procedure that may be executed in the following states: 1) After system initialization. 2) After recovering from a PTL fault incident. 3) During LTW period under normal system operation.

During this PTL safety check procedure, the high-voltage Switch 6 is momentarily open and the load 4 is disconnected. The only voltage on the PTL 3 is generated by the SELV voltage source 9, which is current-limited, and the only load to the PTL 3 is the reference current sink 24 on the AC-PRX 2. The reverse current from the AUX PSU 22 is blocked and the energy storage components on the AUX PSU 22 supplies the AC-PRX 2 circuits during the LTW period.

The PTL safety check procedure first initiates a verification of the switch 6 and may also verify the reference current sink 24 by executing a test-the-tester procedure. Next, the AC-PTX 1 and/or the AC-PRX 2 sample the PTL voltage and current within a defined sampling window. At the end of the sampling window period, the sampled PTL voltage is tested against three boundaries, each defined by two thresholds. The boundaries may be defined according to one of the five configurations depicted by the graphs 1100-1500 in FIGS. 11 to 15.

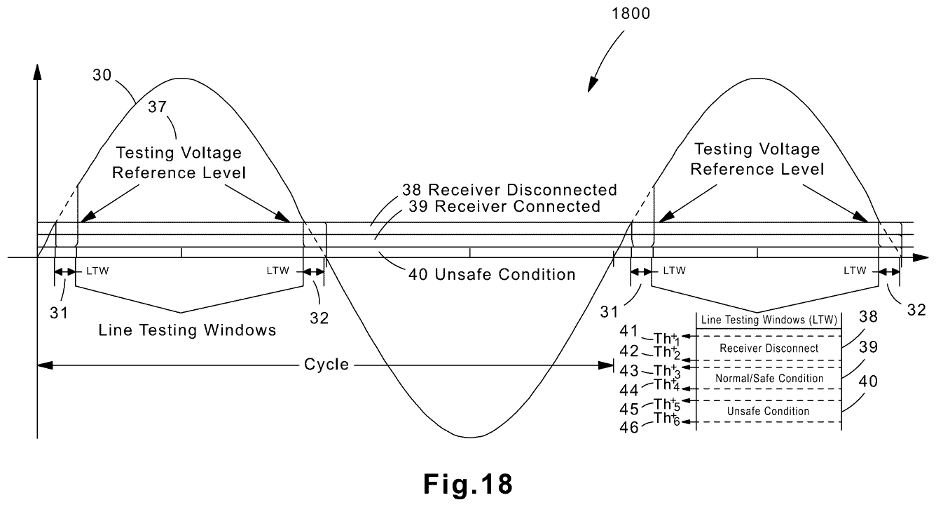

For example, FIG. 18 shows a graph 1800 depicting the boundaries for Configuration-1, where the boundaries are defined with reference to the parameters provided in the graph 1100 shown in FIG. 11. More specifically, the boundaries for Configuration-1 and defined as follows:
1) The AC-PRX or Cable is disconnected; defined by Th⁺₁, Unit (41), and Th⁺₂, Unit (42), boundary.
   This scenario causes a high impedance on the PTL (i.e., floating) as current sink 24, on AC-PRX, does not sink any current.
   The voltage on the PTL will be relatively close to the voltage generated by SELV voltage source 9, which is defined by Unit (37).
   A slight voltage drop could be resulted from the system's leakage current (if any).
2) The PTL is in Normal/Safe Condition; defined by Th⁺₃, Unit (43), and Th⁺₄, Unit (44), boundary.
   The voltage drop on the PTL will be proportional to current sink 24 sink current on AC-PRX as well as the PTL parasitic capacitance.
3) The PTL is in unsafe condition; defined by Th⁺₅, Unit (45), and Th⁺₆, Unit (46), boundary.
   The voltage drop on the PTL exceeds current sink 24 sink current on AC-PRX, which is caused by either introducing a low impedance or another current path to the PTL. This can be a result of one of the following faults:
      i. Human Touching Cable: Introduces a human-body impedance across PTL.
      ii. Short-circuited Cable: Introduces a very low impedance to PTL.
      iii. Arcing Event: The arc behaves as a non-linear resistance that is directly proportional to its length. Near zero-crossing point, the burning of arcs weakens gradually, and the resistance of the arc increases subsequently due to the de-ionization of the plasma. However, it does not increase to infinity, meaning that the space between the contacts still has some conductance. As a voltage across the gap appears it causes the ions and electrons to accelerate to opposite polarities. Hence, a post-arcing current is formed across the contacts.
      iv. Ground Fault Event: Introduces a human-body impedance between a Line and Ground.
   Assuming that the SELV voltage source 9, is 50V/2.2 mA, the sink current I_{REF}, current sink 24, is 2 mA, and the human body impedance is 2 KΩ.
      Under the normal condition, Unit (6) has a source impedance that can supply the load impedance of current sink 24. The voltage on PTL will be within the boundary defined by Th⁺₃, Unit (43), and Th⁺₄, Unit (44).
      i. If an impedance is added to PTL (i.e., 2 K Ω human touch), the voltage on PTL will collapse during the LTW to the boundary defined by Th⁺₅, Unit (45), and Th⁺₆, Unit (46), because of a combined load impedance of human touch and current sink 24.
      ii. Under Short-circuited Cable scenario during the LTW, the safety circuit will detect a more sever voltage drop (i.e., close to 0V) on the PTL.
      iii. An arcing event can trip the safety circuit in different ways including introduce a series voltage drop on the PTL during the LTW, which falls to the boundary defined by Th⁺₅, Unit (45), and Th⁺₆, Unit (46); an overshoot spike during the LTW, exceeding Th⁺₁, Unit (41); or a switching noise that triggers a false clock recovery and trip the safety circuit that check for line recovery synchronization signal.
      iv. A ground fault event introduces an impedance from the line to the ground causing a current to flow through the reference ground.
         a) If the system has a HRMG configuration, the current flow from line though HRMG is considered under the let-go-limit line (i.e., safe).
         b) If the system has a midtap ground configuration, the current flow from line though the midtap ground will cause a voltage drop on the PTL during the LTW period, which falls to the boundary defined by Th⁺₅, Unit (45), and Th⁺₆, Unit (46), and will be detected by the safety circuits.
4) Unintended High-Voltage is detected on the PTL; defined by exceeding Th⁺₁, Unit (41), level.

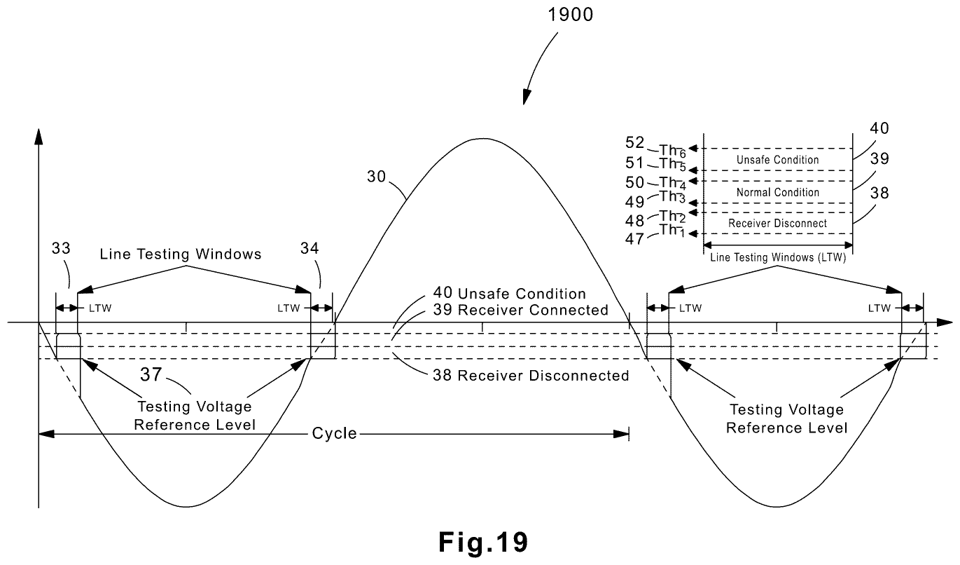

The boundaries for Configuration-2 are depicted in the graph 1900 shown in FIG. 19. The boundaries in this case are defined during the Negative Cycle, hence, they are identical to Configuration-1 but have negative thresholds and defined as follows:
1) The AC-PRX or Cable is disconnected; defined by Th⁻₁, Unit (47), and Th⁻₂, Unit (48), boundary.
2) The PTL is in Normal/Safe Condition; defined by Th⁻₃, Unit (49), and Th⁻₄, Unit (50), boundary.
3) The PTL is in unsafe condition; defined by Th⁻₅, Unit (51), and Th⁻₆, Unit (52), boundary.
4) Unintended High-Voltage is present on the PTL; defined by exceeding Th⁻₁, Unit (47), level.

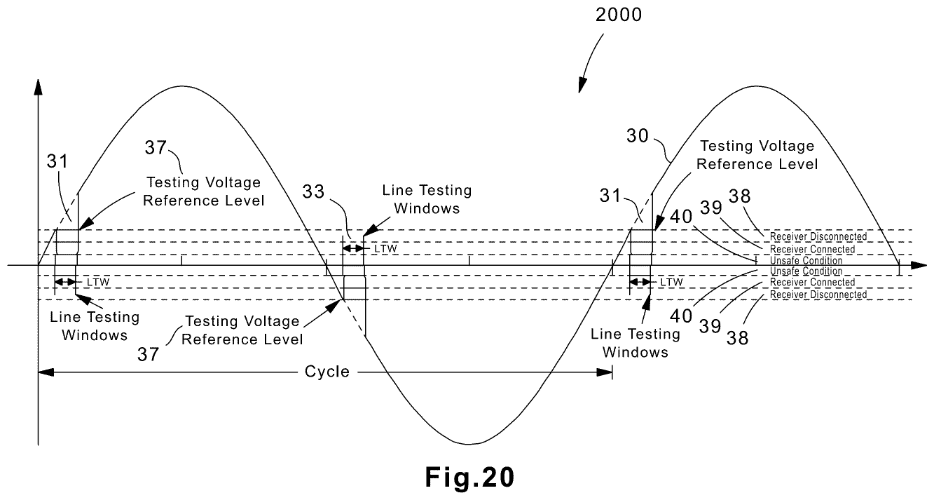

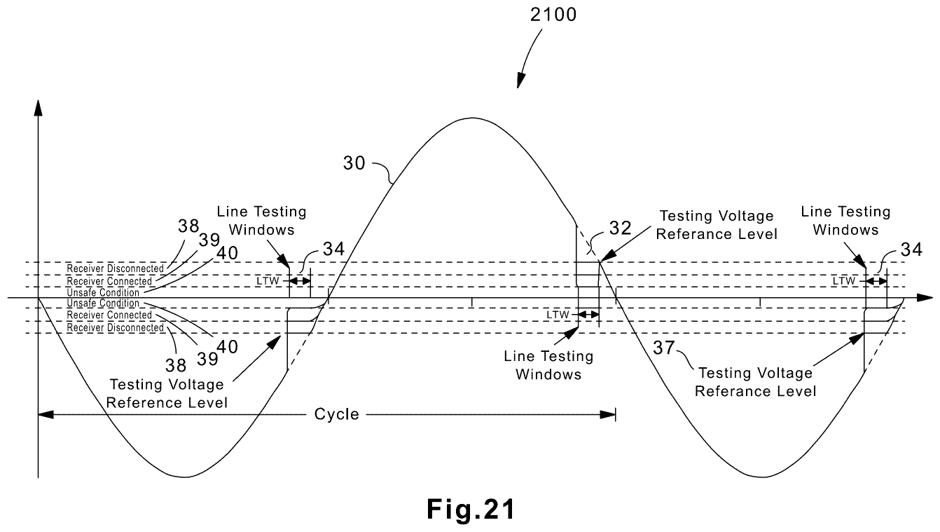

Similarly, FIG. 20 and FIG. 21 depict the boundaries for Configuration-3 and Configuration-4 in the graphs 2000 and 2100, respectively. The advantage of Configuration-3 and Configuration-4 is that they test the line during both Positive and Negative cycles.

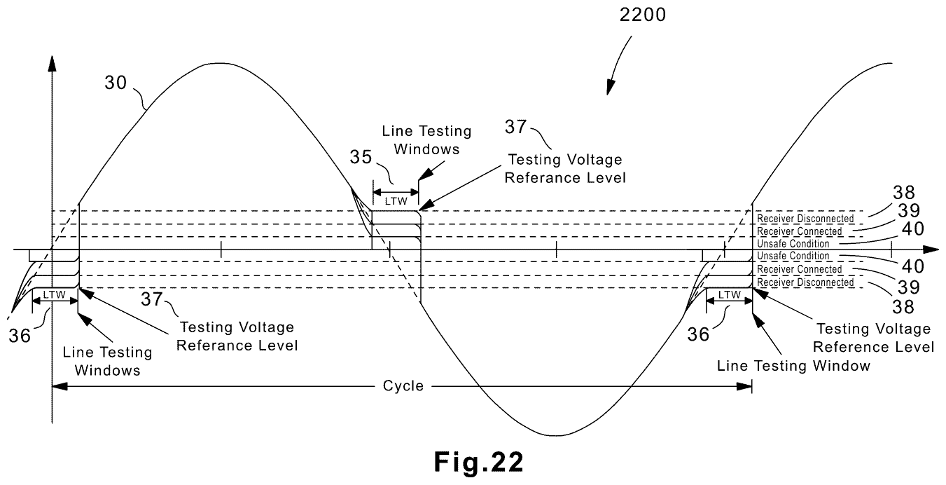

The boundaries for Configuration-5 as described by the graph 2200 shown in FIG. 22, on the other hand, sets the LTW around zero-crossing, which allows to expand the LTW period and provide a smoother transition from the positive to negative cycle and from the negative to positive cycle. The same fault detection scheme in Configuration-1 and 2 applies to all configurations. The difference is at what angles of rotation the LTW starts and ends.

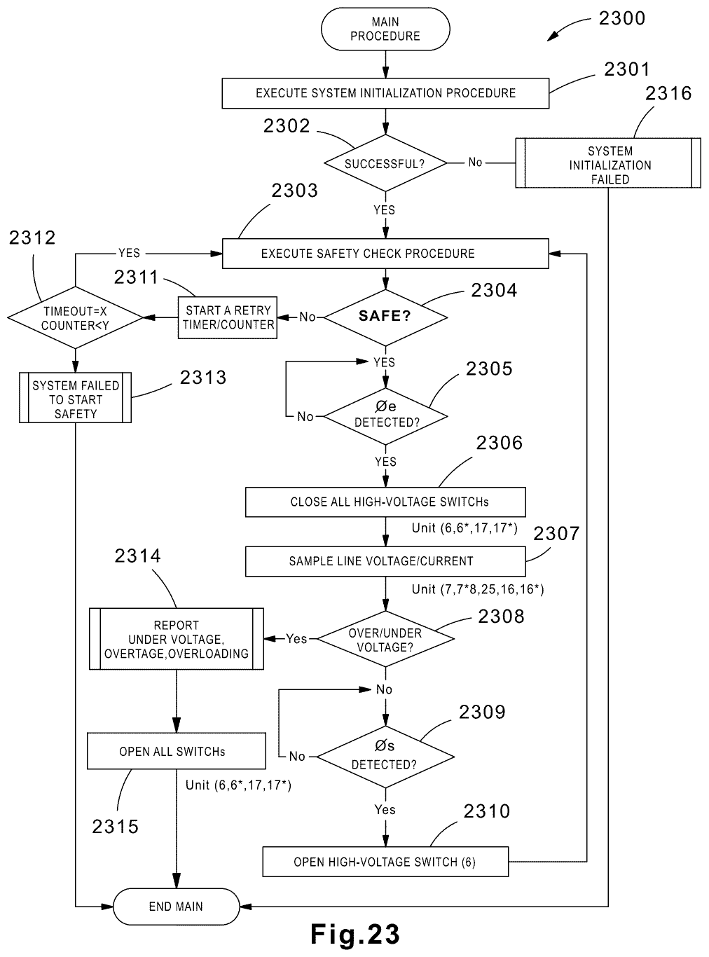

The AC-FMPS main operational process is depicted by the exemplary flowchart 2300 shown in FIG. 23, which encompasses the System Initialization Procedure, Safety Check Procedure, and the Normal Operation Procedure. The procedure depicted by the flowchart 2300 may be executed as follows:

The main operational process first Executes System Initialization, at 2301, and checks if System Initialization was successful, at 2302. If this fails, the procedure will be terminated and must be checked by the operator, at 2316.

If successful, the process executes the PTL Safety Check Procedure to validate the safety of the PTL, at 2303. If this fails, at 2304, a retry timer and counter are initiated, at 2311. The system will retry to execute the Safety Check Procedure after a predefined delay for a predefined number of times, at 2312, before it terminates the process, and the operator must check the system, at 2313.

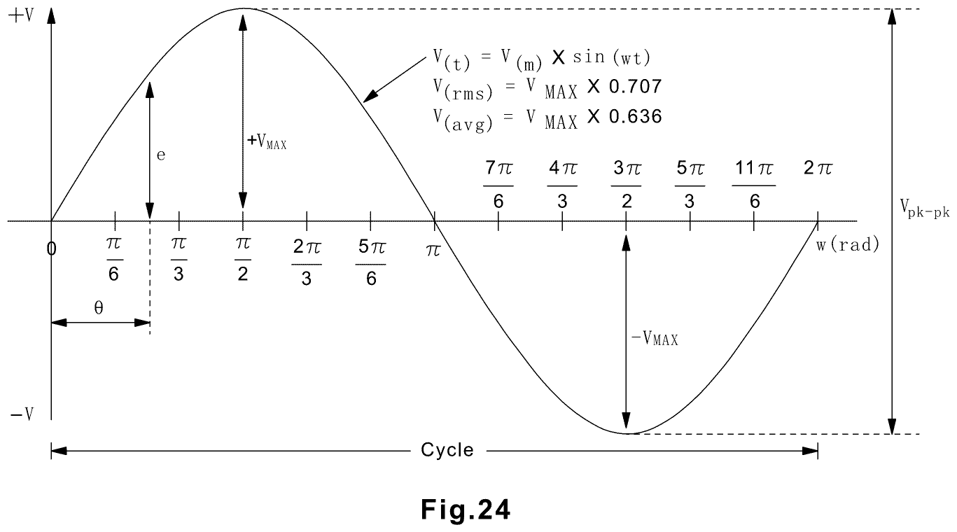

If successful indicating a safe condition, at 2304, the process will wait until the angle of rotation is at the end of the LTW period, Øe, at 2305. The relation of voltage and angle of rotation over one cycle is depicted in FIG. 24.

The safety circuits 11 close the high-voltage switches including switches 6, 6* and switches 17, 17*, and inform the Control Circuits within the safety circuits 19 at the AC-PRX 2 to close the switches 6, 6* and switches 17, 17*, at 2306.

Both safety circuits 11, 19 start sampling the line voltage and current for detecting any abnormalities in the PTL voltage and Current including overvoltage, undervoltage, overcurrent, or short circuit condition, at 2307.

If a voltage abnormality is detected, at 2308, the safety circuits 11 reports the fault condition detected from the voltage abnormality, at 2314, and immediately closes the switches 16, 16* and terminates the process, at 2315, and the operator must check the system.

If not detected, the process continues until the angle of rotation is at the starting point of the LTW period, Øs, at 2309. The Safety Control Circuits in the safety circuits 11 open the high-voltage switches 6, 6* and start executing the Safety Check Procedure, at 2303. The process operates in a continuous loop while the AC-FMPS 100 is operating to detect fault conditions to ensure safe user operation.

It follows that the AC-FMPS 100 provides for a method for fault detection in an AC-FMPS, capable of identifying a range of fault conditions including human contact, arc faults, ground faults, short-circuits, connectivity faults, and voltage irregularities such as undervoltage, overvoltage, overcurrent, and unintended high-voltage on the PTL. This process involves monitoring the line voltage angle of rotation and initiating fault detection when it reaches a set value (Øs) or approaches the zero-crossing point. This includes disconnecting high-voltage switches at the AC-PTX to isolate the PTL during detection, setting a predefined voltage level on the PTL at the AC-PRX side using a SELV source and a current sink, initiating a sampling of the PTL within a defined LTW in this isolated state, and comparing the sampled voltage against defined boundary conditions to ascertain the PTL's operational state. Finally, re-engaging the high-voltage switches at Øe if safe conditions are met, confirming the secure connection of the AC-PRX and the absence of leakage current.

The AC-FMPS 100 also provides for a method for implementing a FMPS with high-voltage AC, characterized by maintaining continuous AC flow in a high-voltage power distribution system without needing voltage rectification or chopping and utilizing high-voltage AC power directly from the grid. The method includes providing direct power class conversion between Class 1 and Class 4, supporting various system topologies like point-to-point and multi-drop connections, and accommodating both single-phase and three-phase AC inputs and outputs in different configurations. The method adapts to either a HRMG or mid-tap ground configuration to enhance line safety and adjusts voltage levels within the AC-FMPS to meet specific operational requirements. The method adapts AC load to be directly connected to the output of the receiver without isolation transformer or rectifying the output for DC loads. The method adapts the input transformer to share its isolated output with multiple transmitting channels and/or combine the rectified output of multiple receivers' channels to supply a higher load capacity.

The AC-FMPS 100 also provides for a procedure for executing the Safety Check Procedure in various states, including after system initialization, post-recovery from a PTL fault incident, and during the LTW under normal system operation. This involves temporarily opening the high-voltage Switch, powering the PTL solely by the SELV source, and loading it with the reference current sink on AC-PRX. The procedure includes testing the sampled PTL voltage against three boundaries, each defined by two thresholds, with the boundaries being configurable based on various operational configurations.

The AC-FMPS 100 also provides for a method employing an angle of rotation detector and a zero-crossing detector to monitor the phase angle and zero-crossing points of the AC waveform within the PTL. This method involves triggering the LTW at predetermined phase angles, conducting safety checks, fault detection, or system diagnostics within the LTW period, sampling the PTL voltage and current within a defined window using AC-PTX and/or AC-PRX, and testing the sampled voltage against predefined boundaries set by threshold pairs to maintain system safety and operational integrity.

The AC-FMPS 100 also provides for a method for detecting abnormalities such as overvoltage, undervoltage, overcurrent, or short-circuit conditions when the power switch is closed, responding appropriately by shutting down units and requiring operator checks.

The AC-FMPS 100 also provides for a method for conducting self-diagnosis tests (Test-the-Tester) to ensure the integrity of safety detection circuits in the AC-FMPS. This includes performing self-validation of safety detection circuits by AC-PTX and AC-PRX, either individually or collaboratively, by introducing predefined voltages, loads, and impedances to the PTL as part of the self-check and comparing measurements obtained during the self-check to reference values to assess the response of the safety detection circuits to introduced fault scenarios.

The AC-FMPS 100 also provides for a method for integrating an RF communication layer in an AC-FMPS, enhancing system functionalities. This method includes implementing an RF communication layer over the PTL within the AC-FMPS, utilizing the RF layer for real-time communication between different units of the AC-FMPS, transmitting control signals, system status, and diagnostic data. It enhances system safety through immediate RF communication in response to detected faults or operational anomalies, facilitates efficient system management and control via RF communication, and integrates data reporting functionalities through the RF layer for comprehensive system performance analysis and early detection of potential issues.

As is readily apparent from the foregoing, various non-limiting exemplary embodiments of an AC-FMPS solution have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. An Alternating Current Fault Managed Power System (AC-FMPS) comprising:
a power transmission line;
a power transmitter coupled to a first end of the power transmission line, the power transmitter comprising:
a power supply configured to transmit a high-voltage AC power onto the power transmission line;
a voltage sensor configured to sense a voltage on the power transmission line;
a Safety Extra Low Voltage supply (SELV supply) configured to transmit a low voltage power on the power transmission line;
a safety switch configured to disrupt the transmission of the high-voltage AC power onto the power transmission line;
a safety circuit configured to:
receive a sensed voltage of the power transmission line from the voltage sensor;
perform a fault detection test on the power transmission line during a line testing window period; and
control the safety switch to open when a fault is detected on the power transmission line based on a sensed voltage received from the voltage sensor.

2. The AC-FMPS of claim 1, wherein the line testing window occurs during one of a positive cycle or a negative cycle of a sinusoidal waveform representing the high-voltage AC power.

3. The AC-FMPS of claim 1, wherein the line testing window occurs during a positive cycle and a negative cycle of a sinusoidal waveform representing the high-voltage AC power.

4. The AC-FMPS of claim 1, wherein the line testing window occurs during a zero crossing of a sinusoidal waveform representing the high-voltage AC power.

5. The AC-FMPS of claim 1, wherein the line testing window is comprised of at least a first voltage range corresponding to a safe condition and a second voltage corresponding to a fault condition.

6. The AC-FMPS of claim 5, wherein the line testing window is further comprised of a third voltage range corresponding to an uncertain condition, wherein the third voltage range is outside the first voltage range and the second voltage range.

7. The AC-FMPS of claim 1, wherein the safety circuit is further configured to:
monitor a phase angle corresponding to a sinusoidal waveform representing the high-voltage AC power; and
control the line testing window to occur during a predetermined testing phase angle.

8. The AC-FMPS of claim 1, wherein the safety circuit is further configured to:
monitor a phase angle corresponding to a sinusoidal waveform representing the high-voltage AC power;
control the safety switch to open during a predetermined open phase angle; and
control the safety switch to close during a predetermined close phase angle.

9. The AC-FMPS of claim 1, wherein the fault is detected on the power transmission line when the sensed voltage is greater than a predetermined threshold voltage, wherein the predetermined threshold voltage is determined based on at least one of a predetermined type of fault condition or a current state of the AC-FMPS.

10. The AC-FMPS of claim 1, wherein the fault is detected on the power transmission line when the sensed voltage is lower than a predetermined threshold voltage, wherein the predetermined threshold voltage is determined based on at least one of a predetermined type of fault condition or a current state of the AC-FMPS.

11. The AC FMPS of claim 1, wherein the power transmitter is included in at least one of a point-to-point system topology or a multi-drop topology.

12. The AC FMPS of claim 1, wherein the power transmitter is configured to support single-phase or three-phase power.

13. The AC FMPS of claim 1, the power transmitter further comprising:
a high resistance midpoint ground (HRMG) coupled to an output of the power transmitter.

14. The AC FMPS of claim 1, the power transmitter further comprising:
a mid-tap grounding configuration coupled to an output of the power transmitter.

15. The AC FMPS of claim 1, further comprising:
a power receiver coupled to a second end of the power transmission line, wherein the power receiver is configured to power a load device;
wherein the safety circuit is further configured to:
transmit the low voltage power supplied from the SELV supply on the power transmission line while the safety switch remains open following detection of the fault, wherein the low voltage power is configured to power a reference current sink included in the power receiver while the load device is disconnected from the power receiver;
receive a sensed safety check voltage of the power transmission line from the voltage sensor;
perform a safety check test on the power transmission line during the line testing window period; and
determine a safety condition of the power transmission line based on the sensed safety check voltage being compared to at least a first safety voltage threshold.

16. The AC FMPS of claim 15, wherein the first safety voltage threshold is determined based on whether the line testing window occurs during a positive cycle, a negative cycle, or a zero crossing of a sinusoidal waveform representing the low voltage power supplied from the SELV supply.

17. The AC FMPS of claim 1, further comprising:
a power receiver coupled to a second end of the power transmission line, wherein the power receiver is configured to power a load device, the power receiver including a receiver-side safety circuit configured to detect a fault or safe condition on the power transmission line;
wherein the safety circuit is further configured to:
receive, from the receiver-side safety circuit, a fault condition message or a safe condition message.

18. The AC FMPS of claim 1, wherein the fault corresponds to one of a human contact, an arc fault, a ground fault, a short circuit, a connectivity fault, an overcurrent, an overvoltage, an undervoltage, or an unintended high voltage.

19. An Alternating Current Fault Managed Power System (AC-FMPS) comprising:
a power transmission line;
a power receiver coupled to a second end of the power transmission line, wherein the power receiver is configured to power a load device
a power transmitter coupled to a first end of the power transmission line, the power transmitter comprising:
a power supply configured to transmit a high-voltage AC power onto the power transmission line;
a voltage sensor configured to sense a voltage on the power transmission line;
a Safety Extra Low Voltage supply (SELV supply) configured to transmit a low voltage power on the power transmission line;
a safety switch configured to disrupt the transmission of the high-voltage AC power onto the power transmission line;
a safety circuit configured to:
execute a system initialization procedure;
when the system initialization procedure is determined to be successful, transmit the low voltage power supplied from the SELV supply on the power transmission line while the safety switch remains open, wherein the low voltage power is configured to power a reference current sink included in the power receiver while the load device is disconnected from the power receiver;
receive a sensed safety check voltage of the power transmission line from the voltage sensor;
perform a safety check test on the power transmission line during a line testing window period; and
determine a safety condition of the power transmission line based on the sensed safety check voltage being compared to at least a first safety voltage threshold.

20. The AC FMPS of claim 14, wherein the line testing window occurs during a positive cycle, a negative cycle, or a zero crossing of a sinusoidal waveform representing the low voltage power suppled by the SELV supply.
